(19) United States
(12) Patent Application Publication
(10) Pub. No.: US 2026/0034820 A1
(43) Pub. Date: Feb. 5, 2026

(54) LIQUID COATING DEVICE, IMAGE FORMING APPARATUS, LIQUID COATING METHOD, AND STORAGE MEDIUM

(71) Applicants: Ryusaku HIDA, Kanagawa (JP); Hiroki ISHIHARA, Kanagawa (JP); Kenji NOZAWA, Kanagawa (JP); Hirotaka KOBAYASHI, Kanagawa (JP); Hidetoshi MIGITA, Kanagawa (JP)

(72) Inventors: Ryusaku HIDA, Kanagawa (JP); Hiroki ISHIHARA, Kanagawa (JP); Kenji NOZAWA, Kanagawa (JP); Hirotaka KOBAYASHI, Kanagawa (JP); Hidetoshi MIGITA, Kanagawa (JP)

(21) Appl. No.: 19/275,996

(22) Filed: Jul. 22, 2025

(30) Foreign Application Priority Data
Jul. 30, 2024 (JP) 2024-123615

(51) Int. Cl. B41M 5/00; B41J 11/00

(52) U.S. Cl. CPC B41M 5/0017; B41J 11/0015

(57) ABSTRACT

A liquid coating device includes a storage container, a drain unit, a supply unit, and circuitry. The storage container stores a treatment liquid to be applied to coating targets. The drain unit drains the treatment liquid from the storage container for a drain amount. The supply unit supplies the treatment liquid to the storage container. The circuitry sets a target value related to the drain amount of the treatment liquid smaller than a total capacity of the storage container, calculates a degradation degree of the treatment liquid in the storage container, controls the drain unit to drain the treatment liquid for the drain amount based on the target value when the degradation degree exceeds a threshold of the degradation degree, and controls the supply unit to supply the treatment liquid for a supply amount corresponding to the drain amount.

### CROSS-REFERENCE TO RELATED APPLICATION

This patent application is based on and claims priority pursuant to 35 U.S.C. § 119(a) to Japanese Patent Application No. 2024-123615, filed on Jul. 30, 2024, in the Japan Patent Office, the entire disclosure of which is hereby incorporated by reference herein.

### BACKGROUND

### Technical Field

The present disclosure relates to a liquid coating device, an image forming apparatus, a liquid coating method, and a storage medium storing a plurality of instructions.

### Related Art

An image forming apparatus includes an inkjet apparatus (such as an inkjet printer) that uses a recording head to discharge ink droplets.

### SUMMARY

The present disclosure described herein provides an improved liquid coating device including a storage container, a drain unit, a supply unit, and circuitry. The storage container stores a treatment liquid to be applied to coating targets. The drain unit drains the treatment liquid from the storage container for a drain amount. The supply unit supplies the treatment liquid to the storage container. The circuitry sets a target value related to the drain amount of the treatment liquid smaller than a total capacity of the storage container, calculates a degradation degree of the treatment liquid in the storage container, controls the drain unit to drain the treatment liquid for the drain amount based on the target value when the degradation degree exceeds a threshold of the degradation degree, and controls the supply unit to supply the treatment liquid for a supply amount corresponding to the drain amount.

Further, the present disclosure described herein provides an improved liquid coating method and a non-transitory storage medium storing a plurality of instructions which, when executed by one or more processors, causes the processors to perform a method (i.e., the liquid coating method). The liquid coating method includes storing a treatment liquid to be applied to coating targets in a storage container, draining the treatment liquid from the storage container for a drain amount, supplying the treatment liquid to the storage container, setting a target value related to the drain amount of the treatment liquid smaller than a total capacity of the storage container, calculating a degradation degree of the treatment liquid in the storage container, controlling the draining to drain the treatment liquid for the drain amount based on the target value when the degradation degree exceeds a threshold of the degradation degree; and controlling the supplying to supply the treatment liquid for a supply amount corresponding to the drain amount.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an image forming apparatus including a liquid coating device;

FIG. 2 is a schematic view of a liquid coating device;

FIG. 3 is a block diagram illustrating a hardware configuration of a liquid coating device;

FIG. 4 is a block diagram illustrating a functional configuration of a liquid coating device;

FIGS. 5A and 5B are graphs of a temporal change in viscosity of a treatment liquid stored in a storage container;

FIGS. 6A and 6B are diagrams each illustrating a screen displayed on a panel display unit of a liquid coating device according to a first embodiment of the present disclosure;

FIG. 7 is a flowchart of a procedure in the liquid coating device of FIGS. 6A and 6B, according to the first embodiment;

FIGS. 8A and 8B are flowcharts of procedures of a drain process and a supply process in the liquid coating device of FIGS. 6A and 6B, according to the first embodiment;

FIGS. 9A and 9B are diagrams each illustrating a screen displayed on a panel display unit of a liquid coating device according to a second embodiment of the present disclosure;

FIGS. 10A to 10D are diagrams each illustrating a screen displayed on a panel display unit of a liquid coating device according to a third embodiment of the present disclosure;

FIG. 11 is a flowchart of a procedure of a drain process and a supply process in the liquid coating device of FIGS. 10A to 10D, according to the third embodiment;

FIG. 12 is a block diagram illustrating a functional configuration of a liquid coating device according to a fourth embodiment of the present disclosure;

FIG. 13 is a diagram illustrating a first mode;

FIG. 14 is a diagram illustrating a second mode;

FIG. 15 is a diagram illustrating a first step of a third mode;

FIG. 16 is a diagram illustrating a second step of the third mode of FIG. 15;

FIG. 17 is a diagram illustrating a third step of the third mode of FIG. 15;

FIG. 18 is a flowchart of a procedure in the liquid coating device of FIG. 12, according to the fourth embodiment;

FIG. 19 is another flowchart of a procedure in the liquid coating device of FIG. 12, according to the fourth embodiment; and

FIG. 20 is yet another flowchart of a procedure in the liquid coating device of FIG. 12, according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Currently, an inkjet printer as an image forming apparatus has been rapidly spreading because of advantages such as low noise, low running cost, and ease of color printing. However, when an image is formed on a recording medium other than a special-purpose paper, for example, bleeding, a decrease in density or color tone, and bleed-through of the image may occur, and water resistance and weather resistance of the image may be insufficient. In a technique to enhance image quality, a liquid coating device applies (pre-applies) a treatment liquid (treatment agent solution) having a function of aggregating ink to a sheet as the recording medium. After that, the image forming apparatus discharges ink droplets onto the sheet to which the treatment liquid has been applied.

When the treatment liquid stored in the liquid coating device is left for a long period of time, the moisture and the organic solvent in the treatment liquid evaporate. As a result, the property such as the viscosity or the concentration of the treatment liquid may increase (deteriorate), and the amount of the treatment liquid applied to the recording medium may increase. If the amount of the treatment liquid applied to the recording medium increases, the treatment liquid may bleed on the recording medium, and the frictional force of the recording medium with a roller that conveys the recording medium may decrease, which may cause a conveyance failure of the recording medium. Further, if the amount of the treatment liquid applied to the recording medium increases, the treatment liquid may not be sufficiently dried, and thus an image formed on the recording medium may be transferred to another recording medium in a subsequent process, which may cause the deterioration of the image quality and hinder the speedup of image formation.

In a comparative example, the liquid coating device includes an estimation unit that estimates the concentration of the treatment liquid, and a maintenance unit that performs a maintenance process of replacing the treatment liquid with a new treatment liquid based on a change in the estimated concentration. However, in the technique according to the comparative example, when the deterioration of the property of the treatment liquid exceeds a limit value (i.e., a threshold) in the middle of image formation and the maintenance process is started, the maintenance process takes time to replace the treatment liquid, and thus the work efficiency of the image formation may decrease.

Embodiments of a liquid coating device, an image forming apparatus, a liquid coating method, and a storage medium are described in detail below with reference to the accompanying drawings.

### First Embodiment

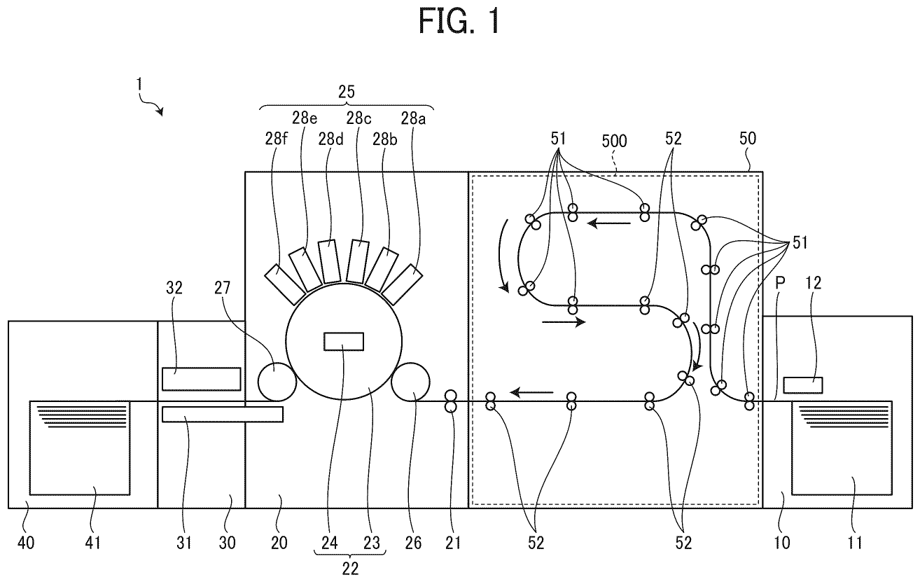

FIG. 1 is a schematic view of an image forming apparatus including a liquid coating device. As illustrated in FIG. 1, an image forming apparatus 1, which is a discharge apparatus, includes a loading device 10, a pre-coating device 50 including a liquid coating device 500, a printing device 20, a drying device 30, and an ejection device 40. In the image forming apparatus 1, the pre-coating device 50 applies a treatment liquid (treatment agent solution) to a sheet P as a recording medium fed from the loading device 10. The treatment liquid prevents ink bleeding and bleed-through. The printing device 20 applies a liquid containing a colorant to the sheet P to print an image on the sheet P. The drying device 30 dries the liquid adhered to the sheet P. Then, the sheet P is ejected to the ejection device 40. The sheet P may be referred to as a “coating target.”

The loading device 10 includes a loading tray 11 on which multiple sheets P are stacked and a feeder 12 to separate and feed the multiple sheets P one by one from the loading tray 11. Any feeding device, such as a device using rollers or a device using air suction, can be used as the feeder 12. The sheet P fed from the loading tray 11 by the feeder 12 is fed to the pre-coating device 50 including the liquid coating device 500.

In the pre-coating device 50, the sheet P is conveyed to the liquid coating device 500 by multiple roller pairs (i.e., conveyance roller pairs 51), and the liquid coating device 500 applies the treatment liquid to the sheet P as the coating target. The sheet P coated with the treatment liquid is fed to the printing device 20 by multiple roller pairs 52.

The printing device 20 includes a registration roller pair 21. The sheet P fed from the pre-coating device 50 reaches the printing device 20, and then the registration roller pair 21 is driven at a predetermined timing to feed the sheet P. The printing device 20 includes a sheet conveyor 22 to convey the sheet P. The sheet conveyor 22 includes a drum 23 and a suction unit 24. The drum 23 bears the sheet P on a circumferential surface thereof and rotates. The suction unit 24 generates a suction force on the circumferential surface of the drum 23.

The printing device 20 further includes a discharge section 25 that discharges and applies a liquid to the sheet P borne and conveyed on the drum 23 of the sheet conveyor 22. The printing device 20 further includes a transfer cylinder 26 that receives the sheet P delivered from the pre-coating device 50 and transfers the sheet P to the drum 23, and a transfer cylinder 27 that transfers the sheet P conveyed by the drum 23 to the drying device 30.

The registration roller pair 21 feeds the sheet P, which is conveyed from the pre-coating device 50 to the printing device 20, to the transfer cylinder 26 at a predetermined timing, and a gripper of the transfer cylinder 26 grips the leading end of the sheet P. The sheet P gripped by the gripper is conveyed as the transfer cylinder 26 rotates. The transfer cylinder 26 forwards the sheet P to the drum 23 at a position opposite the drum 23.

Similarly to the transfer cylinder 26, the drum 23 includes a gripper on the surface thereof, and the leading end of the sheet P is gripped by the gripper. The drum 23 includes multiple suction holes dispersed on the surface thereof. The suction unit 24 sucks air (or generates a suction airflow) through the multiple suction holes of the drum 23 toward an interior of the drum 23. The gripper of the drum 23 grips the leading end of the sheet P transferred from the transfer cylinder 26 to the drum 23, and the sheet P is attracted to and borne on the drum 23 by the suction airflow generated by the suction unit 24. As the drum 23 rotates, the sheet P is conveyed.

The discharge section 25 includes discharge units 28 (28a to 28f) as liquid discharge units. For example, the discharge unit 28a discharges ink of black (K), the discharge unit 28b discharges ink of cyan (C), the discharge unit 28c discharges ink of magenta (M), and the discharge unit 28d discharges ink of yellow (Y). Further, the discharge units 28e and 28f can be used to discharge the liquid of any one of Y, M, C, and K or a liquid of spot color such as white, gold, or silver. Furthermore, the discharge section 25 may include a discharge unit that discharges a treatment liquid such as a surface coating liquid.

For example, the discharge unit 28 is a full line head including multiple liquid discharge heads. Each of the multiple liquid discharge heads includes a nozzle array including multiple nozzles arrayed in a row. The liquid discharge head may be referred to simply as a head.

A discharge operation of each of the discharge units 28 of the discharge section 25 is controlled by a drive signal corresponding to print data. When the sheet P borne on the drum 23 passes through a region facing the discharge section 25, the liquids of respective colors are discharged from the discharge units 28, and an image corresponding to the print data is formed on the sheet P.

The sheet P to which the liquid is applied by the discharge section 25 is forwarded from the surface of the drum 23 to the transfer cylinder 27 as a transfer rotator. Similarly to the drum 23, the transfer cylinder 27 includes a gripper on the surface thereof. After being released from the gripper of the drum 23, the leading end of the sheet P is gripped by the gripper of the transfer cylinder 27 to transfer the sheet P from the drum 23 to the transfer cylinder 27. While rotating, the transfer cylinder 27 conveys the sheet P on the circumferential surface (i.e., a transfer path) thereof and transfers the sheet P to a vacuum conveyor 31 of the drying device 30.

The drying device 30 includes the vacuum conveyor 31 as a conveyor and a dryer 32. The vacuum conveyor 31 conveys the sheet P transferred from the transfer cylinder 27 of the printing device 20 while sucking the sheet P. The dryer 32 dries the liquid on the sheet P conveyed by the vacuum conveyor 31.

The ejection device 40 includes an ejection tray 41 on which the multiple sheets P are stacked. The sheets P conveyed from the drying device 30 are sequentially stacked and held on the ejection tray 41.

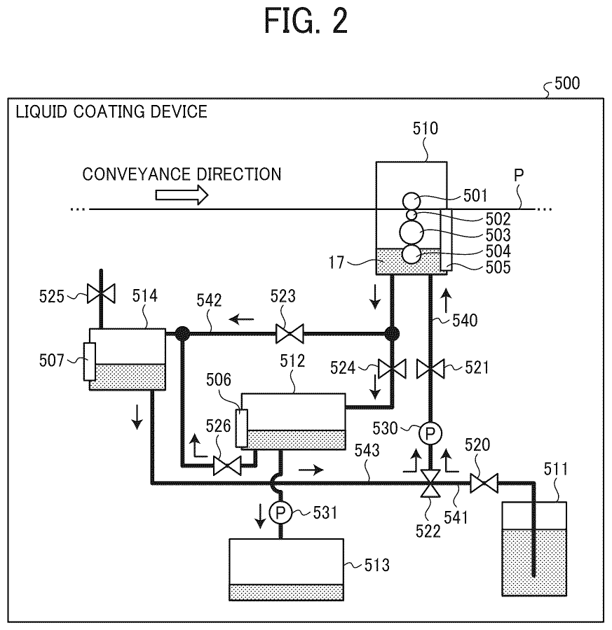

FIG. 2 is a schematic view of the liquid coating device 500. As illustrated in FIG. 2, the liquid coating device 500 includes a storage container 510, a cartridge 511, a reserve tank 512, a waste liquid tank 513, a filter 514, electromagnetic valves 520 to 526, pumps 530 and 531, and sensors 505 to 507.

The storage container 510 stores a treatment liquid 17 to be applied to the sheet P as a coating target. Further, a transfer roller 501, a coating roller 502, a supply roller 503, and a draw-up roller 504 are disposed inside the storage container 510, which may be referred to as a liquid coating mechanism. Each roller is rotatably supported by, for example, side plates of the liquid coating mechanism. The supply roller 503 and the draw-up roller 504 form a nip therebetween. The supply roller 503 is supported via a rotation shaft to form another nip together with the coating roller 502 therebetween. The supply roller 503 may have, for example, a groove formed on the surface thereof to serve as a metering roller that can adjust an application amount by the pitch and depth of the groove.

A coating process of the treatment liquid 17 will be described below. First, the treatment liquid 17 is drawn up by the rotation of the draw-up roller 504 and is carried to the supply roller 503. The treatment liquid 17 passes through a contact position (i.e., the nip) between the draw-up roller 504 and the supply roller 503 to reduce (adjust) the amount of the treatment liquid 17, and is conveyed to the coating roller 502. The treatment liquid 17 passes through a contact position (i.e., the nip) between the supply roller 503 and the coating roller 502 to be measured and formed into a thin film. The sheet P is conveyed by the conveyance roller pairs 51 disposed upstream from the coating roller 502, and is fed to a contact portion between the transfer roller 501 and the coating roller 502. The treatment liquid 17 formed into the thin film on the coating roller 502 is transferred and applied to the sheet P conveyed to the contact portion between the transfer roller 501 and the coating roller 502. The draw-up roller 504, the coating roller 502, and the supply roller 503 may be separated from each other by the thickness of a coating film formed on the surface by the treatment liquid 17, or may be in contact with each other.

The cartridge 511 is filled with a new treatment liquid 17 to be supplied to the storage container 510. The treatment liquid 17 filled in the cartridge 511 is supplied to the storage container 510 through pipes 541 and 540.

The reserve tank 512 stores the treatment liquid 17 drained from the storage container 510. Since the sheet P is fed into the storage container 510 and ejected from the storage container 510, the storage container 510 does not have a completely airtight structure. For this reason, when the treatment liquid 17 is not used for a long time, the electromagnetic valve 524 is opened to transfer the treatment liquid 17 in the storage container 510 to the reserve tank 512 having a highly airtight structure by hydraulic head difference. As a result, the treatment liquid 17 can be prevented from drying, and thus the viscosity of the treatment liquid 17 can be prevented from increasing.

The waste liquid tank 513 stores the treatment liquid 17 drained from the reserve tank 512. When the treatment liquid 17 is not used for a long period of time (for example, several tens of days or more) in the reserve tank 512, the viscosity of the treatment liquid 17 may increase. For this reason, when the treatment liquid 17 is not used for a certain period of time or more in the reserve tank 512, the treatment liquid 17 in the reserve tank 512 is drained to the waste liquid tank 513, and a new treatment liquid 17 is supplied from, for example, the cartridge 511 to maintain the freshness of the treatment liquid 17 in the storage container 510.

The filter 514 removes foreign substances such as paper dust mixed in the treatment liquid 17 in the storage container 510 to prevent the treatment liquid 17 from becoming pasty. The paper dust is generated by, for example, friction when the sheet P is conveyed by rollers.

The electromagnetic valves 520 to 526 open and close pipes at the positions thereof, respectively. For example, a normally open electromagnetic valve that is automatically opened when not energized (when the power supply is turned off) can be used as each of the electromagnetic valves 520 to 526. The pumps 530 and 531 feed the treatment liquid 17 in the pipes at the positions thereof in the directions indicated by the arrows in FIG. 2, respectively.

The sensors 505 to 507 detect a remaining amount of the treatment liquid 17 at the positions thereof, respectively. Each of the sensors 505 to 507 includes, for example, multiple liquid level detection sensors that respectively detect liquid levels at different heights to detect the remaining amount of the treatment liquid 17 in each of the storage container 510, the reserve tank 512, and the filter 514.

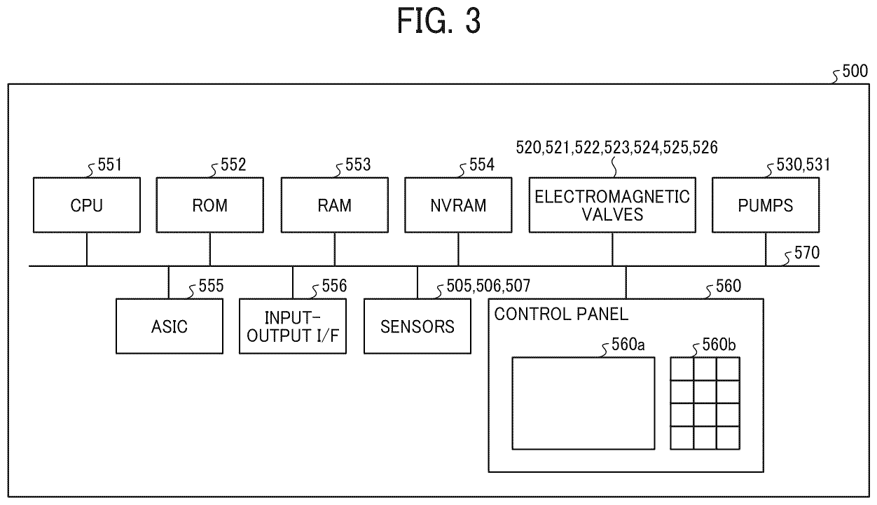

FIG. 3 is a block diagram illustrating a hardware configuration of the liquid coating device 500. In addition to the above-described configuration, the liquid coating device 500 includes a central processing unit (CPU) 551, a read-only memory (ROM) 552, a random-access memory (RAM) 553, a nonvolatile random-access memory (NVRAM) 554, an application-specific integrated circuit (ASIC) 555, an input-output interface (I/F) 556, a control panel 560, and a bus line 570.

The CPU 551 controls the overall operation of the liquid coating device 500. The ROM 552 stores a program such as an initial program loader (IPL) to drive the CPU 551. The RAM 553 is used as a work area for the CPU 551. The NVRAM 554 stores various kinds of data such as programs and retains the various kinds of data even while the liquid coating device 500 is powered off. The ASIC 555 performs various types of signal processing on data and processing of input and output signals for other controls. The input-output I/F 556 acquires data detected by the sensors 505 to 507.

For example, the control panel 560 includes a panel display unit 560a such as a touch panel that displays a current setting value and a selection screen and receives an input from a user, and an operation key 560b including a numeric keypad to input a setting value such as a parameter for the liquid coating device 500. The panel display unit 560a is an example of a display unit. The panel display unit 560a receives a touch input from the user. The user can perform operations such as inputting numerical values to an input box displayed on the screen, selecting a pull-down menu, and turning on and off a check box, using, for example, a finger or a pen. The operation key 560b may include an input device such as a trackball or a touch pad in addition to the numeric keypad. The bus line 570 is, for example, an address bus or a data bus to electrically connect components such as the CPU 551.

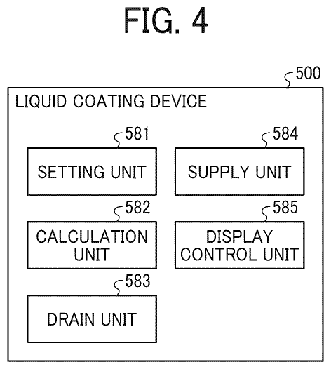

FIG. 4 is a block diagram illustrating a functional configuration of the liquid coating device 500. The liquid coating device 500 includes a setting unit 581, a calculation unit 582, a drain unit 583, a supply unit 584, and a display control unit 585 to form a controller as circuitry.

The functions of these functional units are executed by programs on the CPU 551.

The functions of these functional units may be executed by an information processing apparatus such as a personal computer (PC) or an arithmetic device such as an application-specific integrated circuit (ASIC), a digital signal processor (DSP), or a field-programmable gate array (FPGA).

The setting unit 581 sets data indicating a drain amount of the treatment liquid 17 to be drained from the storage container 510. The data indicating the drain amount is, for example, a target value (target drain amount) of the volume or mass of the drain amount. In this case, the setting unit 581 sets the target drain amount to an amount smaller than the total capacity of the storage container 510. The total capacity indicates the total amount of the treatment liquid 17 that can be stored in the storage container 510. The data indicating the drain amount may be a target property value (e.g., target viscosity), which is a target value of the property of the treatment liquid 17 after the treatment liquid 17 is drained from the storage container 510 and the new treatment liquid 17 is supplied to the storage container 510. Examples of the property of the treatment liquid 17 include the viscosity and the concentration of the treatment liquid 17, which indicate the deterioration of the treatment liquid 17. In this case, the setting unit 581 sets the target property value to a value exceeding the value of the property of the treatment liquid without deterioration (e.g., new treatment liquid or treatment liquid before use).

The data indicating the drain amount may be a ratio of the target drain amount to a total capacity Q0. The data indicating the drain amount may be a ratio of the target viscosity to a viscosity limit Vs of the treatment liquid 17.

The viscosity limit Vs is a limit value of the viscosity of the treatment liquid 17 that does not cause a problem in image quality or a process speed of images formed in an image formation process next to the coating process of the liquid coating device 500. When the viscosity of the treatment liquid 17 is higher than the viscosity limit Vs, the treatment liquid 17 is drained from the storage container 510, and a new treatment liquid 17 is supplied to the storage container 510 to reduce the viscosity of the treatment liquid 17. The target viscosity is an example of a target property value, which is the target value of the property of the treatment liquid 17.

The calculation unit 582 calculates an estimated value of the property of the treatment liquid 17 stored in the storage container 510. The estimated value of the property indicates a degradation degree of the treatment liquid 17 in the storage container 510. Examples of the property of the treatment liquid 17 include the viscosity and the concentration of the treatment liquid 17. When the property of the treatment liquid 17 is viscosity, the calculation unit 582 can calculate an estimated value V of the viscosity by the following Equation 1 or 2. The estimated value V of the viscosity may be referred to simply as a “viscosity V.” Equation 1 is a calculation formula when the treatment liquid 17 is not drained from the storage container 510, and Equation 2 is a calculation formula when the treatment liquid 17 is drained from the storage container 510.

V=Vp+(V0−Vp×Qc)+V0×Qe/Q0 Equation 1

V=Vp+(V0−Vp×(Qc+Qt))+V0×Qe/Q0 Equation 2

In Equations 1 and 2, Vp represents an estimated value calculated in a previous calculation, V0 represents the viscosity of the new treatment liquid 17, Qc represents the liquid amount (consumed liquid amount) consumed in accordance with printing, Qe represents the liquid amount (evaporation amount) reduced by evaporation, and Qt represents the liquid amount (drain amount) drained from the storage container 510.

The calculation unit 582 can calculate the consumed liquid amount Qc based on the application area on the sheet P and the number of printed sheets from the previous calculation. In other words, the calculation unit 582 can calculate the consumed liquid amount Qc based on the number of the sheets P on which the image forming apparatus 1 has formed images. As described above, the property of the treatment liquid 17 is calculated based on the number of the sheets P used in the image formation, and the treatment liquid 17 is drained or supplied as described later. Thus, a drain process (drainage) or a supply process of the treatment liquid 17 can be performed at an appropriate timing.

The calculation unit 582 can calculate the evaporation amount Qe based on the elapsed time from the previous calculation to the current calculation and the operating time of the coating process of the liquid coating device 500. The calculation unit 582 can calculate the drain amount Qt based on the time (the operating time of the pump 531) of the drain process (the processing of draining the treatment liquid 17 from the storage container 510) performed from the previous calculation to the current calculation.

The drain unit 583 performs the drain process when the viscosity V calculated by the calculation unit 582 exceeds the limit value (i.e., the viscosity limit Vs). For example, the drain unit 583 includes the electromagnetic valve 524 and the reserve tank 512. The drain unit 583 opens the electromagnetic valve 524 to drain the treatment liquid 17 in the storage container 510 to the reserve tank 512 for the drain amount. At this time, the drain unit 583 drains the treatment liquid 17 from the storage container 510 by the drain amount according to the data indicating the drain amount set by the setting unit 581. For example, when a target drain amount Q_{N} is set as the data indicating the drain amount, the drain unit 583 drains the treatment liquid 17 from the storage container 510 by the target drain amount Q_{N}. When a ratio of the target drain amount Q_{N} to the total capacity Q0 is set to a percentage of N % as the data indicating the drain amount, the drain unit 583 drains the treatment liquid 17 corresponding to N % of the total capacity Q0 from the storage container 510.

The supply unit 584 performs the supply process (a process of supplying a new treatment liquid 17 to the storage container 510) along with the drain process performed by the drain unit 583. For example, the supply unit 584 includes the electromagnetic valves 520 to 522, the pump 530, and the cartridge 511. The supply unit 584 opens the electromagnetic valves 520 and 521, causes the electromagnetic valve 522 to connect the pipe 540 and the pipe 541, and drives the pump 530 to supply the new treatment liquid 17 from the cartridge 511 to the storage container 510 through the pipe 541 and the pipe 540. The supply unit 584 supplies a supply amount of the new treatment liquid 17 corresponding to the drain amount by the drain process to the storage container 510 to reduce the viscosity of the treatment liquid 17 to a desired value. In other words, the property of the treatment liquid 17 is recovered to a desired value, and thus images can be formed at high speed with sufficient image quality.

The drain unit 583 and the supply unit 584 can obtain the drain amount and the supply amount of the treatment liquid 17 using the change in data detected by the sensors 505 to 507. For example, the drain amount of the treatment liquid 17 drained from the storage container 510 is obtained using the change (decrease amount) in the remaining amount of the treatment liquid 17 detected by the sensor 505.

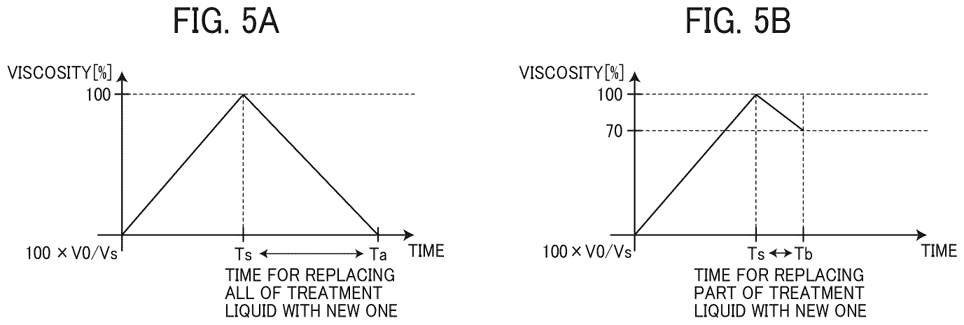

FIGS. 5A and 5B are graphs of a temporal change in the viscosity of the treatment liquid 17 stored in the storage container 510. In FIGS. 5A and 5B, the horizontal axis of the graph represents time, and the vertical axis represents the viscosity of the treatment liquid 17 indicated as percentages (%). The lowest value of the viscosity corresponds to the viscosity V0 of the new treatment liquid 17. In the graph of FIG. 5A, the treatment liquid 17 is replaced according to a comparative technique. The viscosity increases from the minimum value with time, and reaches the limit value (100%) at a time Ts. Then, the treatment liquid 17 is replaced in a maintenance process. In this case, the replacement of all the treatment liquids 17 is completed in a time Ta.

In the graph of FIG. 5B, the drain process and the supply process according to the present embodiment are performed. In this example, a target viscosity of 70% is set as the data indicating the drain amount. Similarly to FIG. 5A, the viscosity reaches the limit value (100%) at the time Ts, but the viscosity is reduced by the drain process and the supply process, and the processes are completed at a time Tb at which the viscosity reaches the target viscosity. As described above, the data indicating the drain amount is set, and the drain process and the supply process are performed by the drain amount indicated by the set data. Accordingly, the processing of recovering the property of the treatment liquid 17 to the desired value can be completed in a shorter time than in the comparative technique.

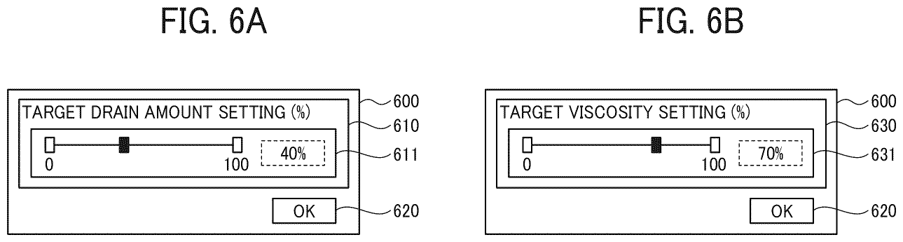

The display control unit 585 displays a screen for the user to interactively set the data indicating the drain amount on the panel display unit 560a. FIGS. 6A and 6B are diagrams each illustrating a screen displayed on the panel display unit 560a according to a first embodiment of the present disclosure. As illustrated in FIG. 6A, a screen 600 displayed on the panel display unit 560a includes a target drain amount setting region 610 and an execution button 620 indicated by “OK.” The target drain amount setting region 610 has a slide bar 611 for the user to set the target drain amount. In this example, the user sets the percentage of N % to the ratio of the target drain amount Q_{N} to the total capacity Q0. The initial value of the ratio of the target drain amount is, for example, 100%, and the user can change and set the setting value of the slide bar 611 by operating a pointing device such as a mouse or a touch panel with a finger. The target drain amount set by the slide bar 611 may be displayed as a numerical value as indicated by a broken line portion of the slide bar 611.

The execution button 620 indicated by “OK” in FIG. 6A is a button for confirming the set target drain amount. When the user clicks the execution button 620 with, for example, the pointing device, the target drain amount set by the slide bar 611 is determined, and the drain unit 583 drains the treatment liquid 17 of the set target drain amount at the time of the next drain process. The setting and change of the target drain amount may be input by the numeric keypad of the operation key 560b.

FIG. 6B illustrates a screen for the user to set the target viscosity as the data indicating the drain amount. The difference from FIG. 6A is that the screen 600 includes a target viscosity setting region 630 instead of the target drain amount setting region 610. The target viscosity setting region 630 has a slide bar 631, and the user can set the ratio of the target viscosity to the viscosity limit Vs of the treatment liquid 17 using the slide bar 631.

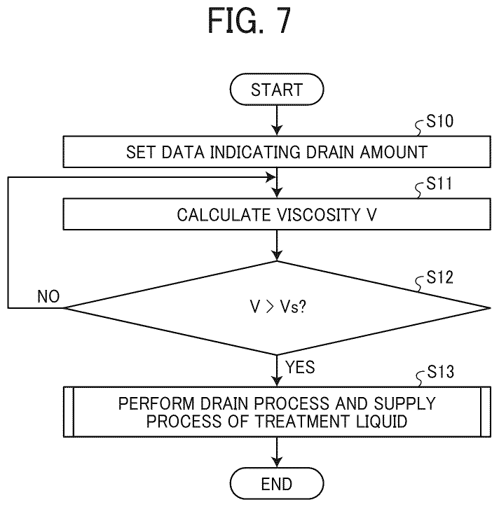

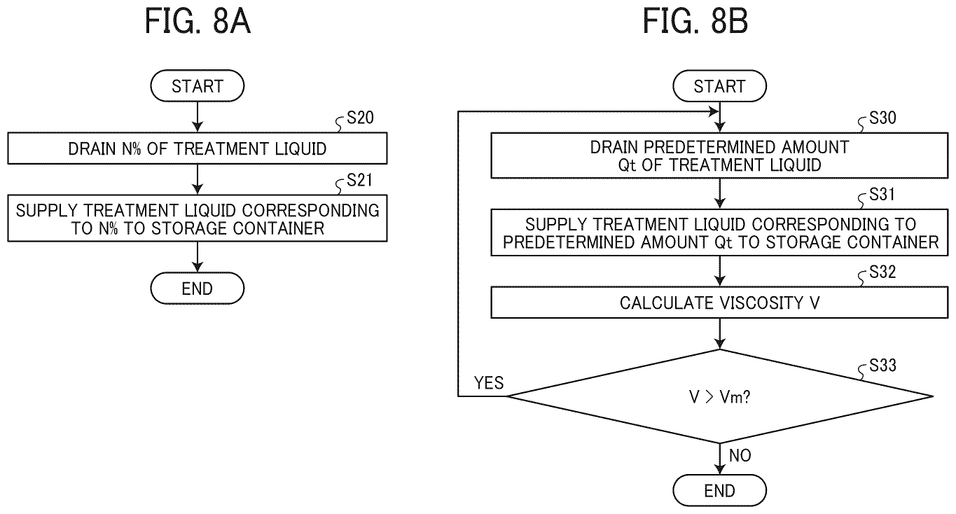

The flows of the drain process and the supply process of the treatment liquid 17 will be described below with reference to FIGS. 7 and FIGS. 8A and 8B. FIG. 7 is a flowchart of a procedure in the liquid coating device 500 according to the first embodiment. In step S10, the setting unit 581 sets the data indicating the drain amount based on an input operation of the user. In step S11, the calculation unit 582 calculates the viscosity V. Then, when the calculated viscosity V is not higher than the viscosity limit Vs (No in step S12), the process returns to step S11. On the other hand, when the calculated viscosity V is higher than the viscosity limit Vs (Yes in step S12), in step S13, the drain unit 583 and the supply unit 584 perform the drain process and the supply process.

FIGS. 8A and 8B are flowcharts of a procedure of the drain process and the supply process according to the first embodiment. In FIG. 8A, the ratio (N %) of the target drain amount Q_{N} to the total capacity Q0 is set as the data indicating the drain amount. In step S20, the drain unit 583 performs the drain process of draining the treatment liquid 17 corresponding to N % of the total capacity Q0. In step S21, the supply unit 584 performs the supply process of supplying a new treatment liquid 17 corresponding to N % of the total capacity Q0 in accordance with the drain process.

In FIG. 8B, a target viscosity Vm is set as the data indicating the drain amount. In step S30, the drain unit 583 performs the drain process of draining a predetermined drain amount Qt of the treatment liquid 17. In step S31, the supply unit 584 performs the supply process of supplying a supply amount of the new treatment liquid 17 corresponding the predetermined drain amount Qt in accordance with the drain process. In step S32, the calculation unit 582 calculates the viscosity V. When the viscosity V is higher than the target viscosity Vm (Yes in step S33), the process returns to step S30. On the other hand, when the viscosity V is not higher than the target viscosity Vm (No in step S33), the process ends. As described above, when the target viscosity Vm (target property value) is used as the data indicating the drain amount, the drain unit 583 starts the drain process when the viscosity Vis higher than the viscosity limit Vs (when the estimated value exceeds the limit value). Then, the drain unit 583 continues the drain process when the viscosity V is higher than the target viscosity value Vm (when the estimated value exceeds the target property value), and the drain unit 583 stops the drain process when the viscosity V is not higher than the target viscosity value Vm (when the estimated value does not exceed the target property value).

When a ratio Xm (Xm=100×Vm/Vs) of the target viscosity Vm to the viscosity limit Vs is set as the data indicating the drain amount, in step S33, the controller of the liquid coating device 500 determines whether a ratio X (X=100×V/Vs) of the viscosity V to the viscosity limit Vs is higher than the ratio Xm.

As described above, the data indicating the drain amount is set, and the drain process and the supply process are performed according to the data indicating the set drain amount. Accordingly, the processing of recovering the property of the deteriorated treatment liquid 17 can be completed in a shorter time than in the comparative technique, and a decrease in the work efficiency of image formation can be prevented. Further, the amount of the treatment liquid 17 to be drained and supplied can be adjusted, and thus the cost of the treatment liquid 17 can be reduced when the frequency of use of the image forming apparatus 1 is low.

Although the limit value of the property is the upper limit value in the above description, the limit value may be the lower limit value. In the case of the lower limit value, the limit value is the lower limit value of the property that does not cause a problem in image quality or a process speed of images formed in an image formation process next to the coating process of the liquid coating device 500. For example, “when exceeding the limit value” indicates that the property (estimated value) is smaller than the limit value. Similarly, “when exceeding the target property value” indicates that the property (estimated value) is smaller than the limit value, and “when not exceeding the target property value” indicates that the property (estimated value) is not smaller than the limit value. For example, the viscosity of the treatment liquid may decrease when the treatment liquid deteriorates. Alternatively, another property such as fluidity, which is the inverse of the viscosity, may be used.

### Second Embodiment

In a second embodiment of the present disclosure, the display control unit 585 displays the property of the treatment liquid 17 on the panel display unit 560a as the display unit. In the following description of the second embodiment, descriptions of elements overlapped with those in the first embodiment are omitted, and differences from the first embodiment are described.

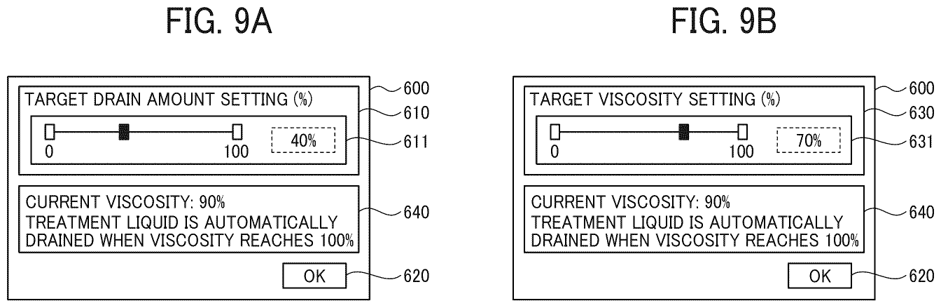

FIGS. 9A and 9B are diagrams each illustrating a screen displayed on the panel display unit 560a according to the second embodiment. The difference from FIGS. 6A and 6B is that the screen 600 further includes a property display region 640, and that the display control unit 585 displays the property calculated by the calculation unit 582 in the property display region 640. In FIGS. 9A and 9B, the current viscosity is displayed as an example of the property. The user checks the property display region 640 to know whether the current viscosity of the treatment liquid 17 is approaching the viscosity limit Vs (whether the ratio of the viscosity V to the viscosity limit Vs is approaching 100%), and for example, the user can manually perform the drain process and the supply process. FIG. 9A illustrates a screen for the user to set the target drain amount as the data indicating the drain amount, and FIG. 9B illustrates a screen for the user to set the target viscosity as the data indicating the drain amount.

As described above, the display control unit 585 displays the property of the treatment liquid 17 on the panel display unit 560a (i.e., the display unit). Accordingly, the user can check the current property of the treatment liquid 17, can determine whether to perform the drain process manually, and can set the data indicating the drain amount based on the current property. Thus, unnecessary drain process and supply process can be prevented, and the drain process and the supply process can be performed at appropriate timings.

### Third Embodiment

In a third embodiment of the present disclosure, the setting unit 581 sets a threshold (property threshold) that does not exceed the limit value of the property of the treatment liquid 17, and the drain process is performed when the property exceeds the property threshold. In the following description of the third embodiment, descriptions of elements overlapped with those in the first and second embodiments are omitted, and differences from the first and second embodiments are described.

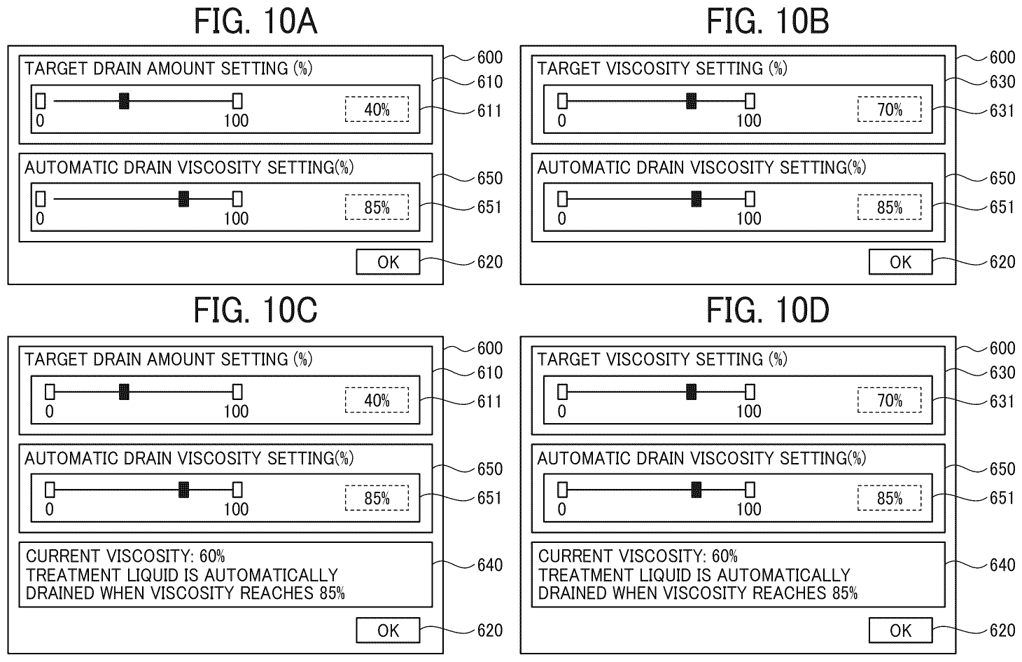

FIGS. 10A to 10D are diagrams each illustrating a screen displayed on the panel display unit 560a according to the third embodiment. The difference from FIGS. 6A and 6B and FIGS. 9A and 9B is that the screen 600 further includes a property threshold setting region 650. In each of FIGS. 10A to 10D, the viscosity is used as an example of the property. The drain process is automatically started when the viscosity of the treatment liquid 17 exceeds the set property threshold. The caption “automatic drain viscosity setting” is displayed in the property threshold setting region 650.

In FIG. 10A, the property threshold setting region 650 is added to the screen 600 of FIG. 6A. In FIG. 10B, the property threshold setting region 650 is added to the screen 600 of FIG. 6B. In FIG. 10C, the property threshold setting region 650 is added to the screen 600 of FIG. 9A. In FIG. 10D, the property threshold setting region 650 is added to the screen 600 of FIG. 9B. In each of FIGS. 10A to 10D, the property threshold setting region 650 has a slide bar 651, and the user can set the ratio of the property threshold of the viscosity to the viscosity limit Vs of the treatment liquid 17 using the slide bar 651. The initial value of the property threshold value of the viscosity is, for example, 100%, and the user can change and set the setting value of the slide bar 651. The property threshold set by the slide bar 651 may be displayed as a numerical value as indicated by a broken line portion of the slide bar 651. The user clicks the execution button 620 to determine the values set by the slide bar 611 and the slide bar 651. In this way, a value that does not exceed the viscosity limit Vs is set as the property threshold of the viscosity.

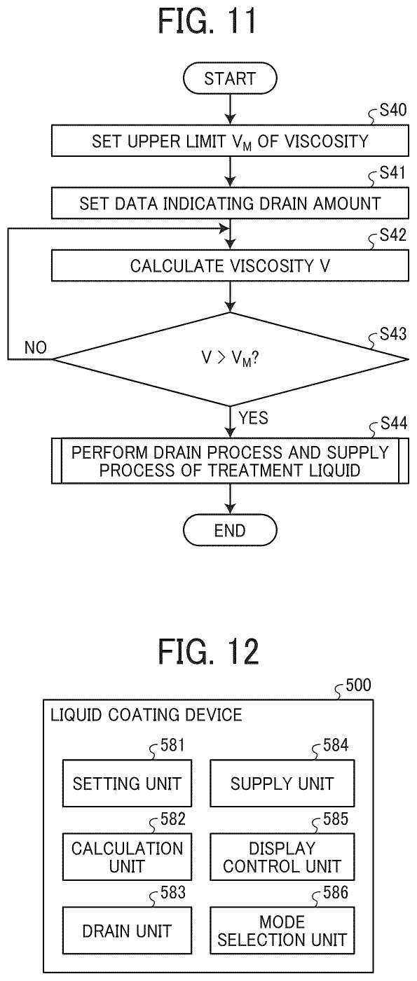

FIG. 11 is a flowchart of a procedure in the liquid coating device 500 according to the third embodiment. The difference from FIG. 7 is that, in step S40, a property threshold V_{M} of the viscosity is set, and that, in step S43, the controller of the liquid coating device 500 determines whether the viscosity V is higher than the property threshold V_{M}. The operations of steps S41, S42, and S44 are the same as the operations of steps S10, S11, and S13 in FIG. 7.

In step S40, the setting unit 581 sets the property thresholds V_{M} of the viscosity based on the input operation of the user. When the viscosity V is not higher than the property threshold V_{M} (No in step S43), the process returns to step S42. On the other hand, when the viscosity V is higher than the property threshold V_{M} (Yes in step S43), in step S44, the drain unit 583 and the supply unit 584 perform the drain process and the supply process.

As described above, a value that does not exceed the limit value of the property of the treatment liquid 17 is set as the property threshold. Accordingly, the drain process and the supply process of the treatment liquid 17 can be performed at an early stage. Thus, the drain process can be performed in accordance with the user's convenience. In addition, the process of recovering the property of the treatment liquid 17 to a desired value can be completed in a shorter time, and the work efficiency of image formation can be enhanced.

Although the property threshold is the upper limit value in the above description, the property threshold may be the lower limit value. In the case of the lower limit value, for example, “when exceeding the property threshold” indicates that the property (estimated value) is smaller than the property threshold.

### Fourth Embodiment

In a fourth embodiment of the present disclosure, the drain unit 583 and the supply unit 584 have multiple processing modes, and perform the drain process and the supply process according to a processing mode selected from the multiple processing modes. In the following description of the fourth embodiment, descriptions of elements overlapped with those in the first to third embodiments are omitted, and differences from the first to third embodiments are described.

FIG. 12 is a block diagram illustrating a functional configuration of the liquid coating device 500 according to the fourth embodiment. The fourth embodiment is different from the first to third embodiments in that the liquid coating device 500 further includes a mode selection unit 586, and that the drain unit 583 and the supply unit 584 perform the drain process and the supply process according to a processing mode selected by the mode selection unit 586.

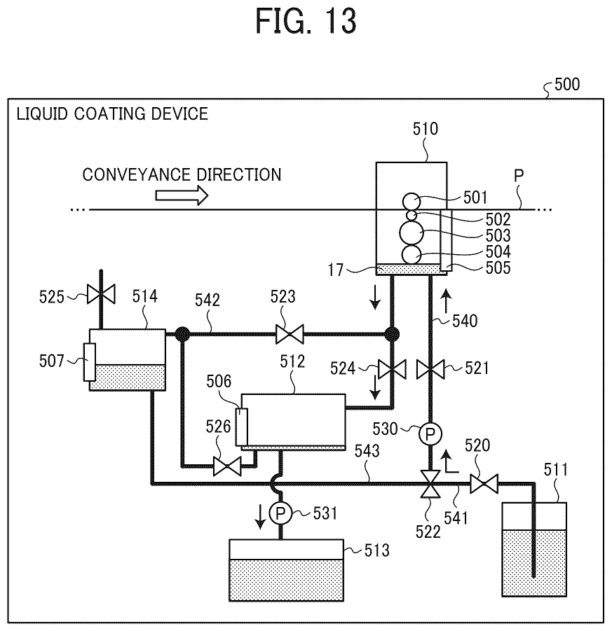

The mode selection unit 586 selects one processing mode from the multiple processing modes. The multiple processing modes include, for example, a first mode in which the filter 514 is not used, a second mode in which the filter 514 is used, and a third mode in which the liquid coating mechanism is cleaned. These processing modes will be described below with reference to FIGS. 13 to 17.

### First Mode

FIG. 13 is a diagram illustrating the first mode. The drain unit 583 opens the electromagnetic valve 524 to drain the treatment liquid 17 in the storage container 510 to the reserve tank 512. The drain unit 583 drives the pump 531 to drain the treatment liquid 17 in the reserve tank 512 to the waste liquid tank 513. The supply unit 584 opens the electromagnetic valves 520 and 521, causes the electromagnetic valve 522 to connect the pipe 540 and the pipe 541, and drives the pump 530 to supply the new treatment liquid 17 from the cartridge 511 to the storage container 510 through the pipe 541 and the pipe 540.

The first mode is used, for example, immediately before the image formation process because the treatment liquid 17 in the storage container 510 can be quickly drained to the waste liquid tank 513.

### Second Mode

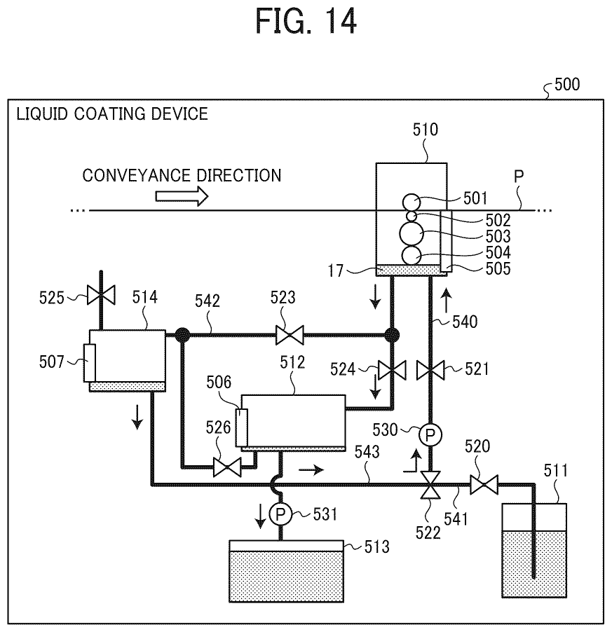

FIG. 14 is a diagram illustrating the second mode. The drain unit 583 drains the treatment liquid 17 in the filter 514 to the waste liquid tank 513 in the following procedure. First, the supply unit 584 opens the electromagnetic valves 525 and 521, causes the electromagnetic valve 522 to connect the pipe 540 and the pipe 543, and drives the pump 530 to supply the treatment liquid 17 in the filter 514 to the storage container 510. Then, as in the first mode, the drain unit 583 opens the electromagnetic valve 524 and drives the pump 531 to drain the treatment liquid 17 in the storage container 510 to the waste liquid tank 513 via the reserve tank 512.

The supply unit 584 opens the electromagnetic valves 520 and 521, causes the electromagnetic valve 522 to connect the pipe 540 and the pipe 541, and drives the pump 530 to supply a new treatment liquid 17 from the cartridge 511 to the storage container 510 through the pipe 541 and the pipe 540.

The second mode takes more time than the first mode, but is used, for example, when the liquid coating device 500 is started after a long stop or when the image forming apparatus 1 is relocated, because the treatment liquid 17 in the filter 514 and the storage container 510 can be drained.

### Third Mode

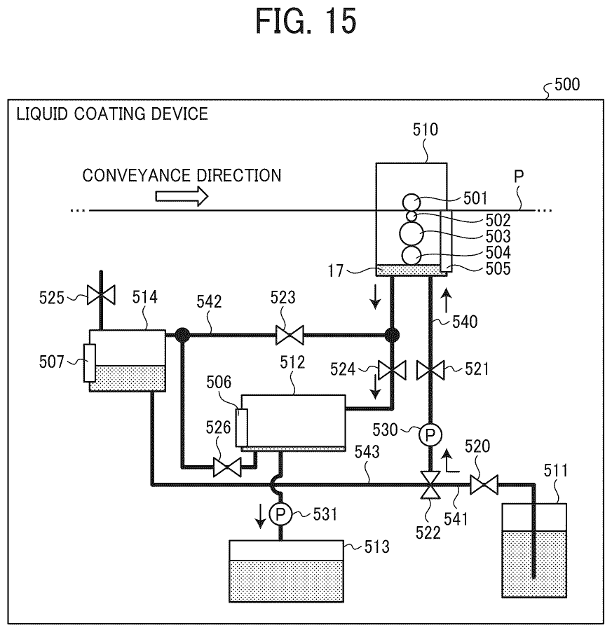

FIG. 15 is a diagram illustrating a first step of the third mode. The drain unit 583 opens the electromagnetic valve 524 and drives the pump 531 to drain the treatment liquid 17 in the storage container 510 to the waste liquid tank 513 via the reserve tank 512, as in the first mode. The supply unit 584 opens the electromagnetic valves 520 and 521, causes the electromagnetic valve 522 to connect the pipe 540 and the pipe 541, and drives the pump 530 to supply the treatment liquid 17 in the cartridge 511 to the storage container 510. Alternatively, the supply unit 584 may open the electromagnetic valves 525 and 521, may cause the electromagnetic valve 522 to connect the pipe 540 and the pipe 543, and may drive the pump 530 to supply the treatment liquid 17 in the filter 514 to the storage container 510.

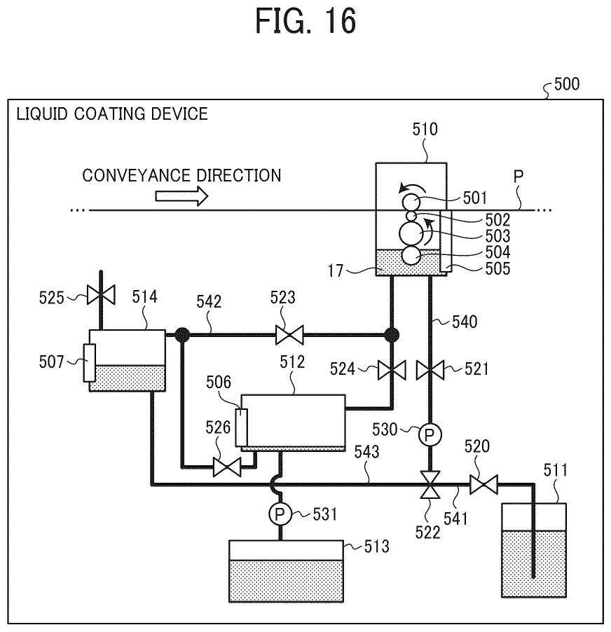

FIG. 16 is a diagram illustrating a second step of the third mode. When the controller of the liquid coating device 500 determines that the level of the treatment liquid 17 has reached the upper end of the draw-up roller 504 based on the remaining amount of the treatment liquid 17 detected by the sensor 505, the liquid coating device 500 rotates the rollers in the storage container 510 to clean the liquid coating mechanism.

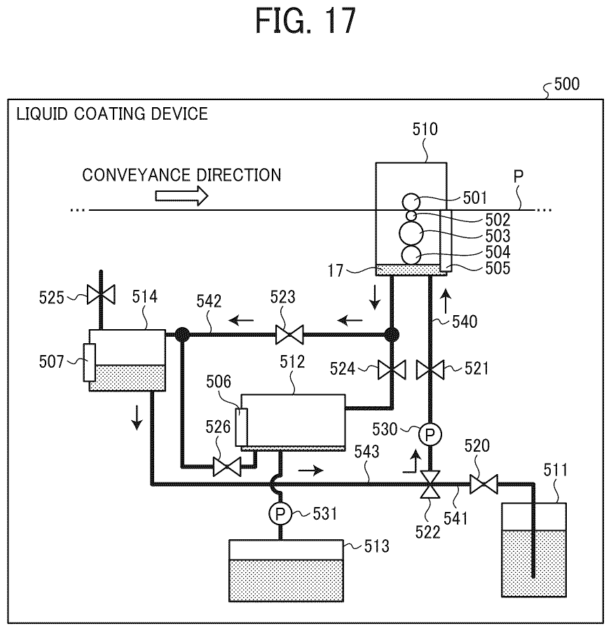

FIG. 17 is a diagram illustrating a third step of the third mode. The liquid coating device 500 opens the electromagnetic valves 521 and 523, causes the electromagnetic valve 522 to connect the pipe 540 and the pipe 543, and drives the pump 530 to circulate the treatment liquid 17 in a circulation path including the pipe 542 and the pipe 543. Thus, the circulation path is cleaned.

Although the third mode takes more time than the second mode, the state of the liquid coating device 500 can get better and the deterioration of the property of the treatment liquid 17 can be prevented by cleaning the liquid coating mechanism and the circulation path. The third mode is used, for example, when the liquid coating device 500 is started after a long stop or when the image forming apparatus 1 is relocated.

The mode selection unit 586 can select the processing mode based on, for example, the property (e.g., viscosity) of the treatment liquid 17 calculated by the calculation unit 582. The drain unit 583 and the supply unit 584 perform the drain process and the supply process according to the processing mode selected by the mode selection unit 586.

For example, the mode selection unit 586 can select the first mode when the viscosity V calculated by the calculation unit 582 is higher than a first viscosity threshold V_{T1} and equal to or less than a second viscosity threshold V_{T2}, and can select the second mode when the viscosity V is higher than the second viscosity threshold V_{T2} and equal to or less than a third viscosity threshold V_{T3}. When the viscosity V is higher than the third viscosity threshold V_{T3}, the mode selection unit 586 can select the third mode.

The mode selection unit 586 may select the processing mode based on the time (e.g., the number of stopped days D) during which the liquid coating device 500 is stopped. For example, the mode selection unit 586 can select the first mode when the number of stopped days D is larger than a first time threshold D_{T1} and equal to or less than a second time threshold D_{T2}, and can select the second mode when the number of stopped days D is larger than the second time threshold D_{T2} and equal to or less than a third time threshold D_{T3}. When the number of stopped days D is equal to the third time threshold D_{T3}, the mode selection unit 586 can select the third mode.

The mode selection unit 586 may select the processing mode based on the combination of the viscosity V calculated by the calculation unit 582 and the time (e.g., the number of stopped days D) during which the liquid coating device 500 is stopped. For example, the mode selection unit 586 can select the first mode when the number of stopped days D is larger than a time threshold D_{T} and the viscosity V is equal to or less than a viscosity threshold V_{T}, and can select the second mode when the viscosity V is higher than the viscosity threshold V_{T} and the number of stopped days D is equal to or less than the time threshold D_{T}. When the number of stopped days D is larger than the time threshold value D_{T} and the viscosity V is higher than the viscosity threshold V_{T}, the mode selection unit 586 can select the third mode.

The values of the respective thresholds are preset, for example, in a manufacturing plant based on experiments. These values may be dynamically changed according to the usage status of the liquid coating device 500.

The mode selection unit 586 may select the processing mode based on a user input to the control panel 560. The initial setting of the processing mode may be set to any mode (for example, the third mode). In this case, the mode selection unit 586 reads the initial setting stored in a storage device, such as the ROM 552 or the NVRAM 554, to select the processing mode.

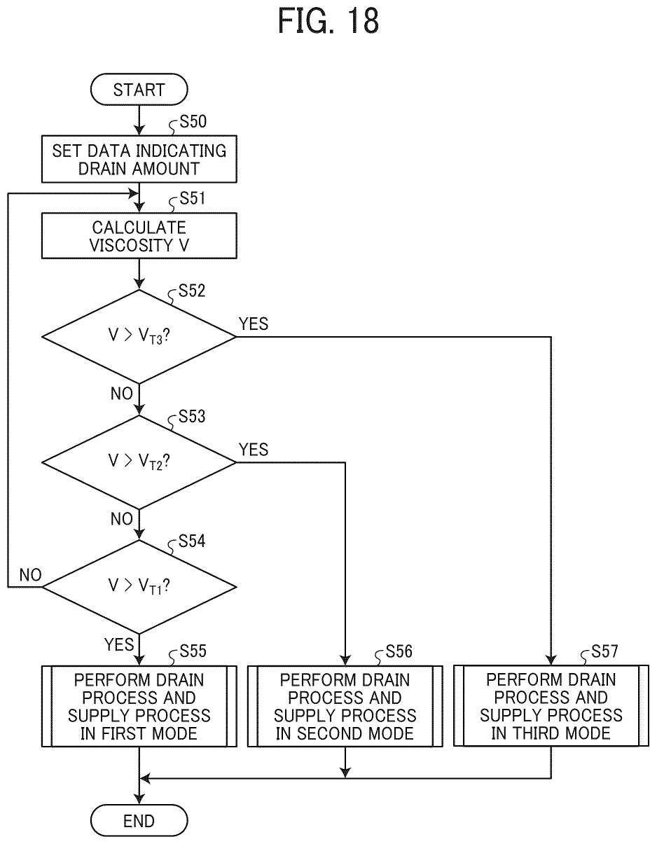

FIG. 18 is a flowchart of a procedure in the liquid coating device 500 according to the fourth embodiment. The difference from FIG. 7 is that the mode selection unit 586 selects a processing mode in steps S52 to S54. The operations of steps S50 and S51 are the same as those of steps S10 and S11 in FIG. 7. The operations of steps S55 to S57 are to perform the same processing as step S13 in FIG. 7 according to the selected processing mode, and thus the description thereof will be omitted.

The mode selection unit 586 selects the third mode when the viscosity V is higher than the third viscosity threshold V_{T3} (Yes in step S52), and the process proceeds to step S57. On the other hand, when the viscosity V is not higher than the third viscosity threshold V_{T3} (No in step S52), the process proceeds to step S53.

The mode selection unit 586 selects the second mode when the viscosity V is higher than the second viscosity threshold V_{T2} (Yes in step S53), and the process proceeds to step S56. On the other hand, when the viscosity V is not higher than the second threshold V_{T2} (No in step S53), the process proceeds to step S54.

The mode selection unit 586 selects the first mode when the viscosity V is higher than the first viscosity threshold V_{T1} (Yes in step S54), and the process proceeds to step S55. On the other hand, when the viscosity V is not higher than the first viscosity threshold V_{T1} (No in step S54), the process returns to step S51.

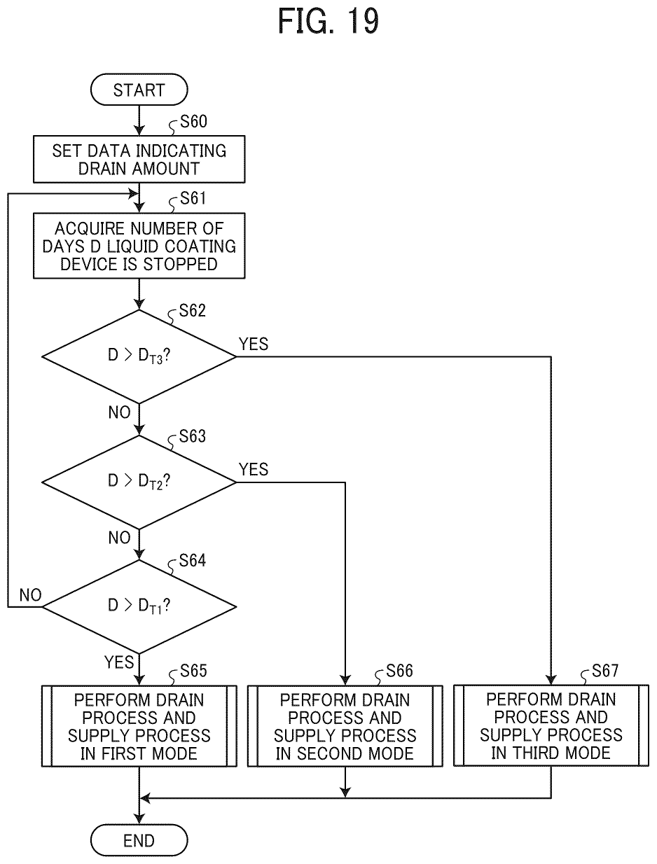

FIG. 19 is another flowchart of a procedure in the liquid coating device 500 according to the fourth embodiment. The difference from FIG. 7 is that the number of stopped days is acquired in step S61, and the mode selection unit 586 selects a processing mode in steps S62 to S64.

The operation of the step S60 is the same as the step S10 in FIG. 7. The operations of steps S65 to S67 are to perform the same processing as step S13 in FIG. 7 according to the selected processing mode, and thus the description thereof will be omitted.

In step S61, the mode selection unit 586 acquires the number of stopped days D during which the liquid coating device 500 is stopped. The mode selection unit 586 selects the third mode when the number of stopped days D is larger than the third time threshold D_{T3} (Yes in step S62), and the process proceeds to step S67. On the other hand, when the number of stopped days D is not larger than the third time threshold D_{T3} (No in step S62), the process proceeds to step S63.

The mode selection unit 586 selects the second mode when the number of stopped days D is larger than the second time threshold D_{T2} (Yes in step S63), and the process proceeds to step S66. On the other hand, when the number of stopped days D is not larger than the second time threshold D_{T2} (No in step S63), the process proceeds to step S64.

The mode selection unit 586 selects the first mode when the number of stopped days D is larger than the first threshold D_{T1} (Yes in step S64), and the process proceeds to step S65. On the other hand, when the number of stopped days D is not larger than the first threshold D_{T1} (No in step S64), the process returns to step S61.

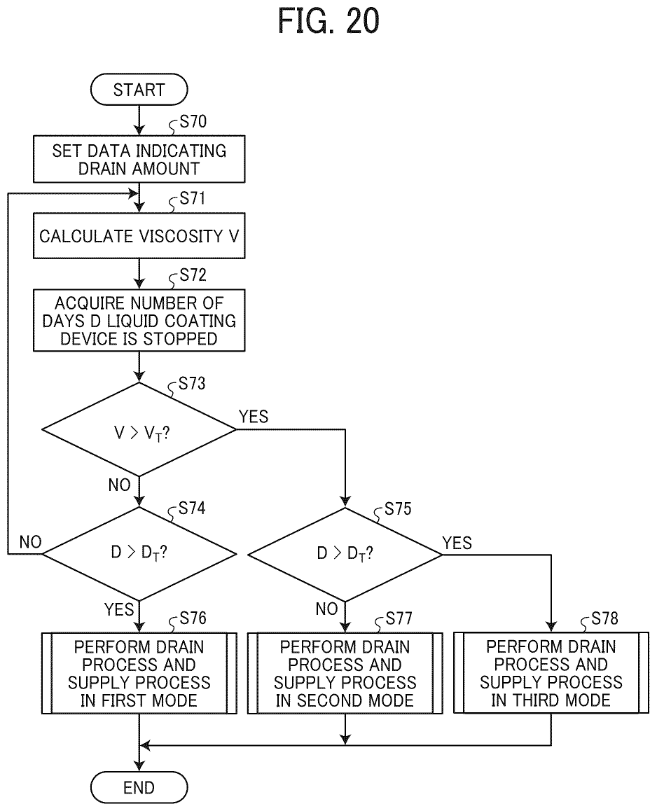

FIG. 20 is yet another flowchart of a procedure in the liquid coating device 500 according to the fourth embodiment. The difference from FIGS. 18 and 19 is that the mode selection unit 586 selects a processing mode by the combination of the viscosity and the number of stop days in steps S73 to S75. The operations of steps S70 and S71 are the same as those of steps S50 and S51 in FIG. 18. The operation of the step S72 is the same as the step S61 of FIG. 19. The operations of steps S76 to S78 are the same as the operations of steps S55 to S57 in FIG. 18.

When the viscosity V is higher than the viscosity threshold V_{T} (Yes in step S73), the process proceeds to step S75. On the other hand, when the viscosity V is not higher than the viscosity threshold V_{T} (No in step S73), the process proceeds to step S74.

The mode selection unit 586 selects the third mode when the number of stopped days D is larger than the time threshold D_{T} (Yes in step S75), and the process proceeds to step S78. On the other hand, the mode selection unit 586 selects the second mode when the number of stopped days D is not larger than the time threshold D_{T} (No in step S75), and the process proceeds to step S77.

The mode selection unit 586 selects the first mode when the number of stopped days D is larger than the time threshold D_{T} (Yes in step S74), and the process proceeds to step S76. On the other hand, when the number of stopped days D is not larger than the time threshold Dr (No in step S74), the process returns to step S71.

As described above, one processing mode can be selected from the multiple processing modes to perform the drain process and the supply process. Accordingly, the processing of recovering the property of the treatment liquid 17 to a desired value can be appropriately performed according to situations, and a decrease in the work efficiency of image formation can be prevented. Although the respective viscosity thresholds are the upper limit value in the above description, the viscosity thresholds may be the lower limit value.

Although some embodiments of the present disclosure have been described above, the above-described embodiments are presented as examples and are not intended to limit the scope of the present disclosure. The above-described novel embodiments can be implemented in other various forms, and various omissions, replacements, and changes can be made without departing from the scope of the present disclosure. Such novel embodiments and variations thereof are included in the scope and gist of the present disclosure and are included in the scope of the appended claims and the equivalent scope thereof. Further, configurations in different embodiments and modifications may be combined as appropriate.

The programs executed on the liquid coating device 500 described above are stored, in an installable or executable file format, in a computer readable storage medium, such as a compact disc-read-only memory (CD-ROM), a flexible disk (FD), a compact disc-recordable (CD-R), and a digital versatile disc (DVD).

Alternatively, the programs executed on the liquid coating device 500 described above may be stored in a computer connected to a network such as the Internet and downloaded via the network. The program executed on the liquid coating device 500 described above may be provided or distributed via a network such as the Internet. Further, the programs may be provided by being incorporated in advance in, for example, the ROM 552.

The program executed on the liquid coating device 500 described above has a modular configuration including the above-described functional units. The CPU 551 (i.e., a processor) serving as actual hardware reads the program from the storage medium described above and executes the program so as to load these units described above on a main storage device to implement the functional units on the main storage device.

Each function of the embodiments described above can be implemented by one processing circuit or multiple processing circuits. The term “processing circuit or circuitry” in the present specification includes a programmed processor to execute each function by software, such as a processor implemented by an electronic circuit, and devices, such as an ASIC, a DSP, an FPGA, and conventional circuit components arranged to perform the recited functions.

In the present disclosure, the term “discharge apparatus” includes a discharge head or a discharge unit and drives the discharge head to discharge a material to be discharged (i.e., a discharge material). The term “discharge apparatus” used here includes, in addition to apparatuses to discharge the discharge material to a medium onto which the discharge material can adhere, apparatuses to discharge the discharge material into gas (air) or liquid.

The “discharge unit” refers to a discharge head integrated with functional components or mechanisms, i.e., an assembly of components related to the discharge of the discharge material. For example, the “discharge unit” includes a combination of the discharge head with at least one of a head tank, a carriage, a supply mechanism, a maintenance mechanism, or a main-scanning moving mechanism.

The above integration may be achieved by, for example, a combination in which the discharge head and a functional component(s) or mechanism(s) are fixed to each other through, e.g., fastening, bonding, or engaging, and a combination in which one of the discharge head and the functional component(s) or mechanism(s) is held movably relative to the other. The discharge head and the functional component(s) or mechanism(s) may be detachably attached to each other.

For example, the discharge head and the head tank are integrated to form the discharge unit as a single unit. Alternatively, the discharge head may be coupled to the head tank through, for example, a tube to form the discharge unit as a single unit. A unit including a filter may further be added to a portion between the head tank and the discharge head of the discharge unit.

Examples of the discharge unit further include a discharge unit in which a discharge head and a carriage are integrated.

As another example, the discharge unit is a unit in which the discharge head and the main-scanning moving mechanism are combined into a single unit. The discharge head is movably held by a guide that is a part of the main-scanning moving mechanism. The discharge unit may include the discharge head, the carriage, and the main-scanning moving mechanism that are integrated as a single unit.

In yet another example, the cap that forms a part of the maintenance mechanism is fixed to the carriage mounting the discharge head so that the discharge head, the carriage, and the maintenance mechanism are integrated as a single unit to form the discharge unit.

Further, in still another example, the discharge unit includes tubes connected to the discharge head mounting the head tank or the channel component so that the discharge head and the supply mechanism are integrated as a single unit. Through the tubes, the discharge material in a storage source of the discharge material is supplied to the discharge head.

The main-scanning moving mechanism may be a guide only. The supply mechanism may be a tube(s) only or a loading device only.

For example, the discharge apparatus may further include devices relating to feeding, conveying, and ejecting of the medium onto which the discharge material can adhere and also include a pretreatment device and an aftertreatment device.

The discharge apparatus may be, for example, an image forming apparatus to form an image on a sheet by discharging ink, or a three-dimensional fabrication apparatus to discharge fabrication liquid to a powder layer in which powder material is formed in layers to form a three-dimensional object.

The discharge apparatus is not limited to an apparatus that discharges the discharge material to visualize meaningful images such as letters or figures. For example, the discharge apparatus may be an apparatus that forms patterns having no meaning or an apparatus that fabricates three-dimensional images.

The above-described term “medium onto which the discharge material can adhere” represents a medium on which the discharge material is at least temporarily adhered, a medium on which the discharge material is adhered and fixed, or a medium into which the discharge material adheres and permeates. Specific examples of the “medium onto which the discharge material can adhere” include, but are not limited to, a medium onto which the discharge material is discharged such as a paper sheet, recording paper, a recording sheet of paper, a film, cloth, a road, or a wall; an electronic component such as an electronic substrate or a piezoelectric element; and a medium such as layered powder, an organ model, or a testing cell. The medium onto which the discharge material can adhere includes any medium to which the discharge material adheres, unless otherwise specified.

Examples of materials for the “medium onto which the discharge material can adhere” include any materials to which the discharge material can adhere even temporarily, such as paper, thread, fiber, fabric, leather, metal, plastic, glass, wood, and ceramic.

Further, when the “material to be discharged (discharge material)” is liquid, the discharge material is not limited to a particular liquid and includes any liquid having a viscosity or a surface tension that can be discharged from the head. However, preferably, the viscosity of the liquid is not larger than 30 millipascal-second (mPa's) under ordinary temperature and ordinary pressure or by heating or cooling. More specifically, examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The discharge apparatus may be an apparatus to move the discharge head and the medium onto which the discharge material can adhere relative to each other. However, the discharge apparatus is not limited to such an apparatus. For example, the discharge apparatus may be a serial head apparatus that moves the discharge head or a line head apparatus that does not move the discharge head.

Examples of the discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

Aspects of the present disclosure are, for example, as follows.

### Aspect 1

A liquid coating device includes a storage container to hold a treatment liquid to be applied to a coating target, a setting unit to set data indicating a drain amount of the treatment liquid to be drained from the storage container, a calculation unit to calculate an estimated value of a property indicating deterioration of the treatment liquid stored in the storage container, a drain unit to perform a drain process of draining the treatment liquid from the storage container in an amount smaller than a total capacity of the storage container according to the data indicating the drain amount set by the setting unit when the estimated value calculated by the calculation unit exceeds a limit value of the property, and a supply unit to perform a supply process of supplying the treatment liquid to the storage container along with the drain process.

In other words, a liquid coating device includes a storage container, a drain unit, a supply unit, and circuitry. The storage container stores a treatment liquid to be applied to coating targets. The drain unit drains the treatment liquid from the storage container for a drain amount. The supply unit supplies the treatment liquid to the storage container. The circuitry sets a target value related to the drain amount of the treatment liquid smaller than a total capacity of the storage container, calculates a degradation degree of the treatment liquid in the storage container, controls the drain unit to drain the treatment liquid for the drain amount based on the target value when the degradation degree exceeds a threshold of the degradation degree, and controls the supply unit to supply the treatment liquid for a supply amount corresponding to the drain amount.

### Aspect 2

In the liquid coating device according to Aspect 1, the setting unit sets a target drain amount, which is a target value of the drain amount smaller than the total capacity of the storage container, as the data indicating the drain amount.

In other words, the circuitry is further configured to set volume or mass of the drain amount smaller than the total capacity of the storage container as the target value.

### Aspect 3

In the liquid coating device according to Aspect 1, the setting unit sets a target property value, which is a target value of the property exceeding a value of the property of the treatment liquid without deterioration, as the data indicating the drain amount. The drain unit starts the drain process when the estimated value calculated by the calculation unit exceeds the limit value, continues the drain process when the estimated value calculated by the calculation unit exceeds the target property value, and stops the drain process when the estimated value calculated by the calculation unit does not exceed the target property value.

In other words, the circuitry sets, as the target value, a target viscosity of the treatment liquid higher than a viscosity of a new treatment liquid and lower than a limit value of the treatment liquid, and calculates a viscosity of the treatment liquid in the storage container as the degradation degree, and controls the drain unit to start a drainage of the treatment liquid from the storage container when the viscosity of the treatment liquid has exceed the limit value, continue the drainage of the treatment liquid from the storage container when the viscosity exceeds the target viscosity, and stop the drainage of the treatment liquid from the storage container when the viscosity does not exceed the target viscosity.

### Aspect 4

The liquid coating device according to any one of Aspects 1 to 3, further includes a display control unit to display the estimated value calculated by the calculation unit on a display unit.

In other words, the liquid coating device according to any one of Aspects 1 to 3, further includes a display. The circuitry displays the degradation degree on the display.

### Aspect 5

In the liquid coating device according to any one of Aspects 1 to 4, the setting unit further sets a property threshold not exceeding the limit value. The drain unit drains the treatment liquid from the storage container in an amount smaller than the total capacity of the storage container according to the data indicating the drain amount set by the setting unit when a value calculated by the calculation unit exceeds the property threshold.

In other words, the circuitry sets the threshold equal to a limit value of the treatment liquid, calculates a viscosity of the treatment liquid in the storage container as the degradation degree, and controls the drain unit to drain the treatment liquid for the drain amount smaller than the total capacity from the storage container according to the target value when the viscosity exceeds the threshold.

Alternatively, the circuitry sets the threshold lower than a limit value of the treatment liquid, calculates a viscosity of the treatment liquid in the storage container as the degradation degree, and controls the drain unit to drain the treatment liquid for the drain amount smaller than the total capacity from the storage container according to the target value when the viscosity exceeds the threshold.

### Aspect 6

In the liquid coating device according to any one of Aspects 1 to 5, the drain unit and the supply unit have multiple processing modes. The liquid coating device further includes a mode selection unit to select a processing mode from the multiple processing modes in accordance with the estimated value calculated by the calculation unit. The drain unit and the supply unit perform the drain process and the supply process in accordance with the processing mode selected by the mode selection unit.

In other words, the circuitry controls the drain unit and the supply unit with multiple processing modes, selects a processing mode from the multiple processing modes according to the degradation degree, controls the drain unit and the supply unit to drain the treatment liquid from the storage container, and supply the treatment liquid to the storage container, according to the processing mode.

### Aspect 7

In the liquid coating device according to any one of Aspects 1 to 6, the property of the treatment liquid is a viscosity of the treatment liquid.

In other words, the circuitry calculates the degradation degree according to a viscosity of the treatment liquid.

Alternatively, the circuitry calculates the degradation degree according to a period during which the liquid coating device is stopped.

### Aspect 8

An image forming apparatus includes the liquid coating device according to any one of Aspects 1 to 7 and an image forming unit to form an image on the coating target to which the treatment liquid has been applied by the liquid coating device.

In other words, an image forming apparatus includes the liquid coating device according to any one of Aspects 1 to 7, to apply the treatment liquid to the coating targets and an image forming device to form images on the coating targets onto which the treatment liquid has been coated by the liquid coating device.

### Aspect 9

In the image forming apparatus according to Aspect 8, the calculation unit calculates the property based on a quantity of the coating target on which the image forming unit has formed the image.

In other words, the circuitry calculates the degradation degree of the treatment liquid based on a number of the coating targets on which the image forming device forms the images.

### Aspect 10

A liquid coating method includes a setting step of setting data indicating a drain amount of a treatment liquid to be drained from a storage container that holds the treatment liquid to be applied to a coating target, a calculation step of calculating an estimated value of a property indicating deterioration of the treatment liquid stored in the storage container, a drain step of performing a drain process of draining the treatment liquid from the storage container in an amount smaller than a total capacity of the storage container according to the data indicating the drain amount set in the setting step when the estimated value calculated in the calculation step exceeds a limit value of the property, and a supply step of performing a supply process of supplying the treatment liquid to the storage container along with the drain process.

In other words, a liquid coating method includes includes storing a treatment liquid to be applied to coating targets in a storage container, draining the treatment liquid from the storage container for a drain amount, supplying the treatment liquid to the storage container, setting a target value related to the drain amount of the treatment liquid smaller than a total capacity of the storage container, calculating a degradation degree of the treatment liquid in the storage container, controlling the draining to drain the treatment liquid for the drain amount based on the target value when the degradation degree exceeds a threshold of the degradation degree; and controlling the supplying to supply the treatment liquid for a supply amount corresponding to the drain amount.

### Aspect 11

A program causes a computer to function as a setting unit to set data indicating a drain amount of a treatment liquid to be drained from a storage container that holds the treatment liquid to be applied to a coating target, a calculation unit to calculate an estimated value of a property indicating deterioration of the treatment liquid stored in the storage container, a drain unit to perform a drain process of draining the treatment liquid from the storage container in an amount smaller than a total capacity of the storage container according to the data indicating the drain amount set by the setting unit when the estimated value calculated by the calculation unit exceeds a limit value of the property, and a supply unit to perform a supply process of supplying the treatment liquid to the storage container along with the drain process.

In other words, a non-transitory storage medium stores a plurality of instructions which, when executed by one or more processors, causes the processors to perform a method. The method includes includes storing a treatment liquid to be applied to coating targets in a storage container, draining the treatment liquid from the storage container for a drain amount, supplying the treatment liquid to the storage container, setting a target value related to the drain amount of the treatment liquid smaller than a total capacity of the storage container, calculating a degradation degree of the treatment liquid in the storage container, controlling the draining to drain the treatment liquid for the drain amount based on the target value when the degradation degree exceeds a threshold of the degradation degree; and controlling the supplying to supply the treatment liquid for a supply amount corresponding to the drain amount.

As described above, according to one aspect of the present disclosure, the property of the deteriorated treatment liquid can be recovered in a short time, and a decrease in the work efficiency of image formation can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid coating device comprising:
a storage container to store a treatment liquid to be applied to coating targets;
a drain unit to drain the treatment liquid from the storage container for a drain amount;
a supply unit to supply the treatment liquid to the storage container; and
circuitry configured to:
set a target value related to the drain amount of the treatment liquid smaller than a total capacity of the storage container;
calculate a degradation degree of the treatment liquid in the storage container;
control the drain unit to drain the treatment liquid for the drain amount based on the target value when the degradation degree exceeds a threshold of the degradation degree; and
control the supply unit to supply the treatment liquid for a supply amount corresponding to the drain amount.

2. The liquid coating device according to claim 1,
wherein the circuitry is further configured to set volume or mass of the drain amount smaller than the total capacity of the storage container as the target value.

3. The liquid coating device according to claim 1,
wherein the circuitry is further configured to:
set, as the target value, a target viscosity of the treatment liquid higher than a viscosity of a new treatment liquid and lower than a limit value of the treatment liquid;
calculate a viscosity of the treatment liquid in the storage container as the degradation degree; and
control the drain unit to:
start a drainage of the treatment liquid from the storage container when the viscosity of the treatment liquid has exceed the limit value;
continue the drainage of the treatment liquid from the storage container when the viscosity exceeds the target viscosity; and
stop the drainage of the treatment liquid from the storage container when the viscosity does not exceed the target viscosity.

4. The liquid coating device according to claim 1, further comprising a display,
wherein the circuitry is further configured to display the degradation degree on the display.

5. The liquid coating device according to claim 1,
wherein the circuitry is further configured to:
set the threshold equal to a limit value of the treatment liquid;
calculate a viscosity of the treatment liquid in the storage container as the degradation degree; and
control the drain unit to drain the treatment liquid for the drain amount smaller than the total capacity from the storage container according to the target value when the viscosity exceeds the threshold.

6. The liquid coating device according to claim 1,
wherein the circuitry is further configured to:
set the threshold lower than a limit value of the treatment liquid;
calculate a viscosity of the treatment liquid in the storage container as the degradation degree; and
control the drain unit to drain the treatment liquid for the drain amount smaller than the total capacity from the storage container according to the target value when the viscosity exceeds the threshold.

7. The liquid coating device according to claim 1,
wherein the circuitry is further configured to:
control the drain unit and the supply unit with multiple processing modes;
select a processing mode from the multiple processing modes according to the degradation degree; and
control the drain unit and the supply unit to:
drain the treatment liquid from the storage container; and
supply the treatment liquid to the storage container,
according to the processing mode.

8. The liquid coating device according to claim 1,
wherein the circuitry is further configured to calculate the degradation degree according to a viscosity of the treatment liquid.

9. The liquid coating device according to claim 1,
wherein the circuitry is further configured to calculate the degradation degree according to a period during which the liquid coating device is stopped.

10. An image forming apparatus comprising:
the liquid coating device according to claim 1, to apply the treatment liquid to the coating targets; and
an image forming device to form images on the coating targets onto which the treatment liquid has been coated by the liquid coating device.

11. The image forming apparatus according to claim 10,
wherein the circuitry is further configured to calculate the degradation degree of the treatment liquid based on a number of the coating targets on which the image forming device forms the images.

12. A liquid coating method comprising:
storing a treatment liquid to be applied to coating targets in a storage container;
draining the treatment liquid from the storage container for a drain amount;
supplying the treatment liquid to the storage container;
setting a target value related to the drain amount of the treatment liquid smaller than a total capacity of the storage container;
calculating a degradation degree of the treatment liquid in the storage container;
controlling the draining to drain the treatment liquid for the drain amount based on the target value when the degradation degree exceeds a threshold of the degradation degree; and
controlling the supplying to supply the treatment liquid for a supply amount corresponding to the drain amount.

13. A non-transitory storage medium storing a plurality of instructions which, when executed by one or more processors, causes the processors to perform a method, comprising:
storing a treatment liquid to be applied to coating targets in a storage container;
draining the treatment liquid from the storage container for a drain amount;
supplying the treatment liquid to the storage container;
setting a target value related to the drain amount of the treatment liquid smaller than a total capacity of the storage container;
calculating a degradation degree of the treatment liquid in the storage container;
controlling the draining to drain the treatment liquid for the drain amount based on the target value when the degradation degree exceeds a threshold of the degradation degree; and
controlling the supplying to supply the treatment liquid for a supply amount corresponding to the drain amount.
